(19) United States
(12) Patent Application Publication
(10) Pub. No.: US 2023/0330836 A1
(43) Pub. Date: Oct. 19, 2023

(54) HIP EXOSKELETON STRUCTURE FOR LIFTING AND PUSHING

(71) Applicant: Arizona Board of Regents on behalf of Arizona State University, Scottsdale, AZ (US)

(72) Inventors: Thomas Sugar, Chandler, AZ (US); Kevin Hollander, Scottsdale, AZ (US); Darren Kinney, Phoenix, AZ (US); William Martin, Gilbert, AZ (US)

(21) Appl. No.: 18/329,228

(22) Filed: Jun. 5, 2023

Related U.S. Application Data
(63) Continuation of application No. PCT/US2021/062081, filed on Dec. 6, 2021.
(60) Provisional application No. 63/122,022, filed on Dec. 7, 2020.

(51) Int. Cl. B25J 9/00; A61H 1/02

(52) U.S. Cl. CPC B25J 9/0006; A61H 1/0244; A61H 2003/007

(57) ABSTRACT

A wearable robotic device includes a hip-mounted, powered exoskeleton, an adjustable vest coupled to the exoskeleton, a power source for powering the exoskeleton, a computing device for controlling the robotic device and determining when to activate the powered exoskeleton. The exoskeleton includes a pair of motor units configurable between a first powered mode wherein the exoskeleton assists in extending the user’s hip and a second free mode wherein the user is able to freely extend or contract the hip.

### CROSS REFERENCE TO RELATED APPLICATIONS

This application is a continuation of PCT Application Serial No. PCT/US2021/062081 filed on Dec. 6, 2021, now International Publication Number WO 2022/125476 entitled “HIP EXOSKELETON STRUCTURE FOR LIFTING AND PUSHING.” PCT Application Serial No. PCT/US2021/062081 claims priority to, and the benefit of, U.S. Provisional Pat. Application Serial No. 63/122,022, filed on Dec. 7, 2020 entitled “HIP EXOSKELETON STRUCTURE FOR LIFTING AND PUSHING.” The entirety of each of the foregoing applications is incorporated herein for all purposes by this reference (including but not limited to those portions that specifically appear hereinafter, but excepting any subject matter disclaimers or disavowals, and except to the extent that the incorporated material is inconsistent with the express disclosure herein, in which case the language in this disclosure shall control).

### TECHNICAL FIELD

The present disclosure relates to robotic systems, and in particular to exoskeletons for use in connection with improving human capability.

### FEDERALLY SPONSORED RESEARCH OR DEVELOPMENT

This invention was made with government support under FA8606-19-C-0018 awarded by the Air Force Office of Scientific Research. The government has certain rights in the invention.

### BACKGROUND

In a wide variety of situations, people of ordinary ability often consume a great deal of energy when walking and carrying a load. Research is being actively conducted into wearable robotics for a variety of applications, for example, enhancement of muscular power of disabled or elderly people to assist them with walking, rehabilitation treatment for people having diseases, and lifting and carrying of heavy loads for soldiers or industrial workers. Accordingly, improved wearable robotic and/or assistive devices remain desirable.

### SUMMARY

In an exemplary embodiment, a robotic device comprises a hip-mounted, powered exoskeleton, an adjustable vest coupled to the powered exoskeleton, a power source for powering the powered exoskeleton, and a computing device for controlling the robotic device and determining when to activate the powered exoskeleton.

In various embodiments, the powered exoskeleton is configured to provide unidirectional thrust to assist hip extension. In various embodiments, the powered exoskeleton provides unidirectional thrust on a portion of hip extension movement of a user. In various embodiments, the powered exoskeleton comprises a first and a second lateral pelvic plate. In various embodiments, the adjustable vest comprises one or more straps configured to reduce rotation of each lateral pelvic plate during activation of the powered exoskeleton. In various embodiments, the adjustable vest comprises a first strap extending horizontally between a first upper end of the first lateral pelvic plate and a second upper end of the second lateral pelvic plate. In various embodiments, the adjustable vest further comprises a second strap extending horizontally between a first lower end of the first lateral pelvic plate and a second lower end of the second lateral pelvic plate. In various embodiments, the adjustable vest further comprises a pair of adjustable shoulder straps.

In another exemplary embodiment, a back support device comprises a first and a second lateral pelvic plate and at least one strap configured to reduce rotation of each lateral pelvic plate and thus support the lumbar region of a user of the back support device.

In various embodiments, the back support device further comprises an adjustable vest coupled to the at least one strap. In various embodiments, the back support device further comprises a plurality of straps that form an adjustable vest. In various embodiments, the first and the second lateral pelvic plate are configured to support the use of a motor to assist a user of the back support device in lifting an object. In various embodiments, each lateral pelvic plate is configured to support the use of a motor to assist a user of the back support device in pushing an object. In various embodiments, each lateral pelvic plate is configured to be coupled to a passive exoskeleton. In various embodiments, the back support device further comprises a quasi-passive exoskeleton coupled to the first and the second lateral pelvic plate, wherein the quasi-passive exoskeleton comprises a power source that can be activated or deactivated.

In various embodiments, the back support device further comprises a powered exoskeleton coupled to the first and the second lateral pelvic plate, wherein the powered exoskeleton comprises a power source and an electric actuator. In various embodiments, the back support device further comprises a pair of motor units respectively coupled to the first and the second lateral pelvic plate. Each motor unit comprises a frame, a motor mounted to the frame, a screw rotatably mounted to the frame, a translating block threadingly coupled to the screw, and a lever arm pivotally coupled to the frame. The translating block is configured to contact the lever arm to rotate the lever arm about a pivot. In various embodiments, the translating block is configured to move from a first mode where the translating block engages the lever arm and a second mode where the lever arm is able to freely rotate about the pivot. In various embodiments, the back support device further comprises a leg brace coupled to the lever arm, wherein the leg brace is configured to rotate with the lever arm about the pivot.

In another exemplary embodiment, a method for using a wearable robotic device comprises positioning a first lateral pelvic plate at a first side of a user’s hip, positioning a second lateral pelvic plate at a second side of the user’s hip, positioning a first strap to extend horizontally between a first upper end of the first lateral pelvic plate and a second upper end of the second lateral pelvic plate, wherein the first strap extends across a user’s waist, adjusting a length of the first strap, positioning a second strap to extend horizontally between a first lower end of the first lateral pelvic plate and a second lower end of the second lateral pelvic plate, wherein the second strap extends across a user’s hip, adjusting a length of the second strap, contracting a user’s hips, and extending the user’s hips with the support of the wearable robotic device.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIGS. 1A, 1B, and 1C illustrate components of an exemplary hip exoskeleton system in accordance with various exemplary embodiments;

FIG. 2A illustrates a front view of an exemplary hip exoskeleton system on a user in accordance with various exemplary embodiments;

FIG. 2B illustrates a side view of an exemplary hip exoskeleton system on a user in accordance with various exemplary embodiments;

FIG. 2C illustrates a back view of an exemplary hip exoskeleton system on a user in accordance with various exemplary embodiments;

FIG. 2D illustrates a side view of a motor unit of an exemplary hip exoskeleton system in accordance with various exemplary embodiments;

FIG. 3 illustrates components of an exemplary hip exoskeleton structure for lifting and pushing in accordance with various exemplary embodiments; and

FIGS. 4A, 4B, 4C, and 4D illustrate views of a lateral pelvic plate of an exemplary hip exoskeleton system in accordance with various embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from principles of the present disclosure.

For the sake of brevity, conventional techniques and components for wearable robotic systems may not be described in detail herein. Furthermore, the connecting lines shown in various figures contained herein are intended to represent exemplary functional relationships and/or physical couplings between various elements. It should be noted that many alternative or additional functional relationships or physical connections may be present in exemplary hip exoskeleton systems and/or components thereof.

Principles of the present disclosure may be compatible with or complementary to principles disclosed in PCT Application No. PCT/US2021/017406 filed on Feb. 10, 2021, now publication WO2021163153 entitled “Hip Exoskeleton for Lifting and Pushing,” the contents of which are hereby incorporated by reference (except for any subject matter disclaimers or disavowals, and except to the extent of any conflict with the disclosure of the present application, in which case the disclosure of the present application shall control).

Wearable robotic systems assist workers to push and lift heavy objects, palletize, and perform tasks with less fatigue. Unfortunately, there is a limited pool of younger workers currently available and the existing workforce is older and aging. Thus, it is desirable to improve worker ergonomics, prevent injuries to reduce health-care costs, and improve worker wellness. For example, more U.S. healthcare dollars are spent treating back and neck pain than almost any other medical condition.

Prior approaches to wearable robotic systems have offered limited performance improvements, been unduly bulky, cumbersome, or heavy. Moreover, most exoskeleton devices do not allow for free motion and hinder walking and running gait. When wearing conventional exoskeleton devices, it feels like you are walking in a swimming pool. In contrast, in accordance with principles of the present disclosure, an exemplary hip exoskeleton can assist human movement, for example, when lifting an object in a squatting position, or when pushing an object, in each instance by assisting hip extension. By providing a system configured to assist with hip extension when lifting and pushing only, exemplary systems allow for free motion in other tasks, improving the user experience.

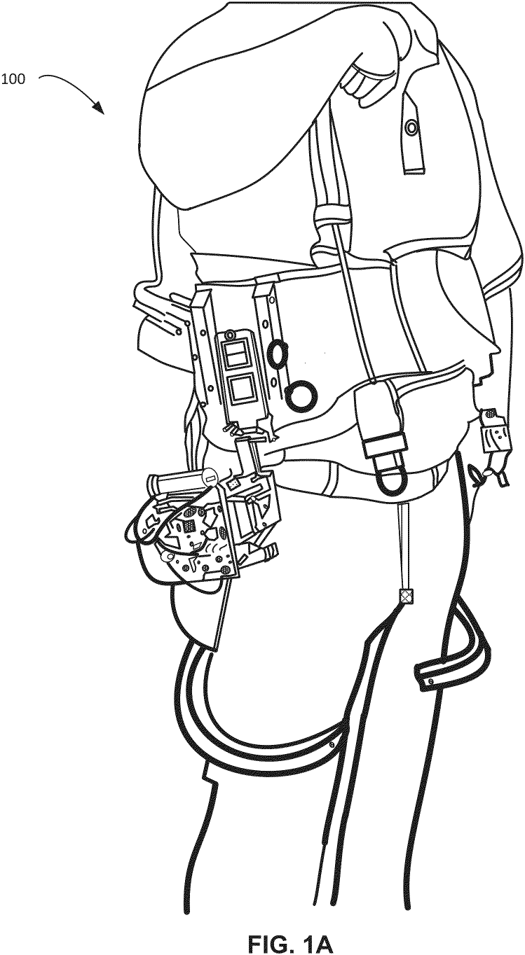

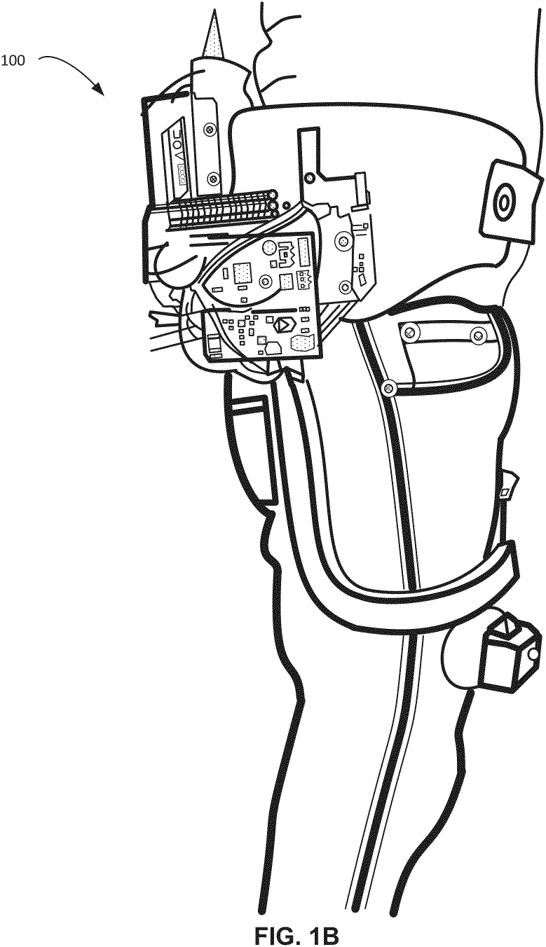

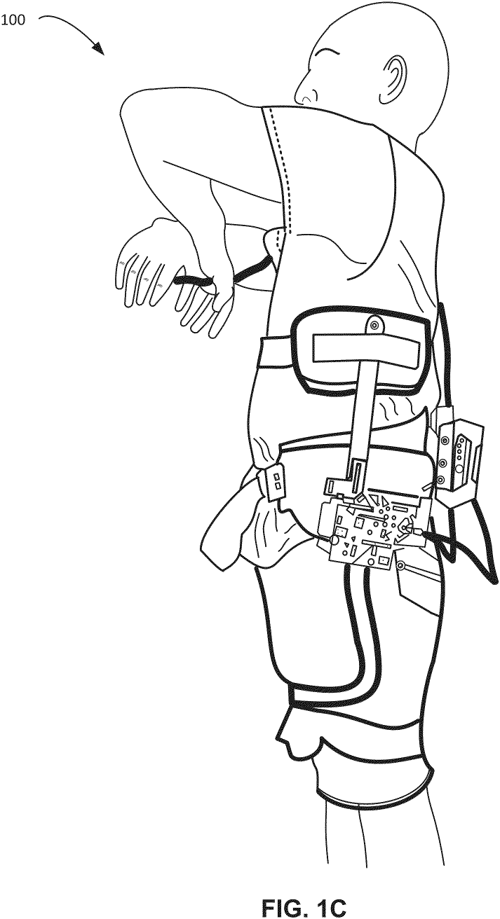

With reference now to FIGS. 1A through 4D, in various exemplary embodiments an exemplary system 100 (also referred to herein as a wearable robotic device and/or a back support device) comprises a hip exoskeleton structure for a lower back system using hard and soft components for a unique, lightweight, and comfortable design. As used herein: “Exoskeleton” means a wearable device consisting of structures that augments, enables, or enhances motion or physical activity; “Passive exoskeleton” means a wearable device consisting of passive structures that augments, enables, or enhances motion or physical activity; “Quasi-Passive exoskeleton” means a wearable device consisting of passive structures that are adjusted (clutched, locked, etc.) to store and release energy based on movement against gravity that augments, enables, or enhances motion or physical activity; “Quasi-Active exoskeleton” means a wearable device consisting of passive structures that are adjusted (pulled, powered, etc.) to store additional energy and release energy that augments, enables, or enhances motion or physical activity; and “Active exoskeleton” means a wearable device consisting of active structures that are adjusted (pulled, powered, etc.) to store, transmit, and release energy that augments, enables, or enhances motion or physical activity.

Prior exoskeleton structures were generally either too soft to resist hip motor torques or were too bulky, stiff, and heavy. Multiple designs have been developed; in some, a system consisting of lateral pelvic plates were used to comfortably resist hip torques. The system constrains the lateral sides of the trunk stabilizing the human core. When a person performs a squatting motion, the lower back is stabilized and good form is achieved.

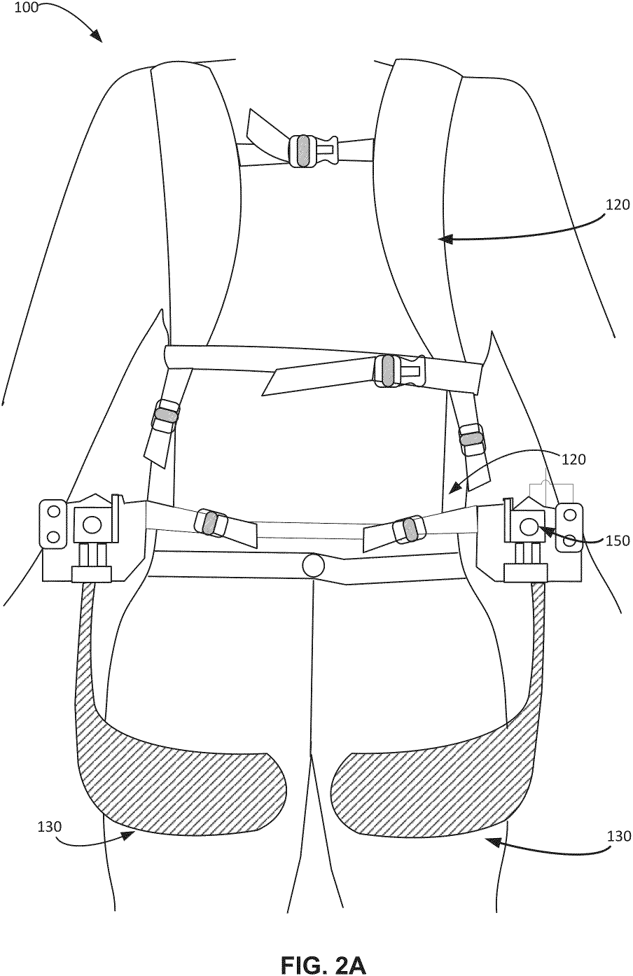

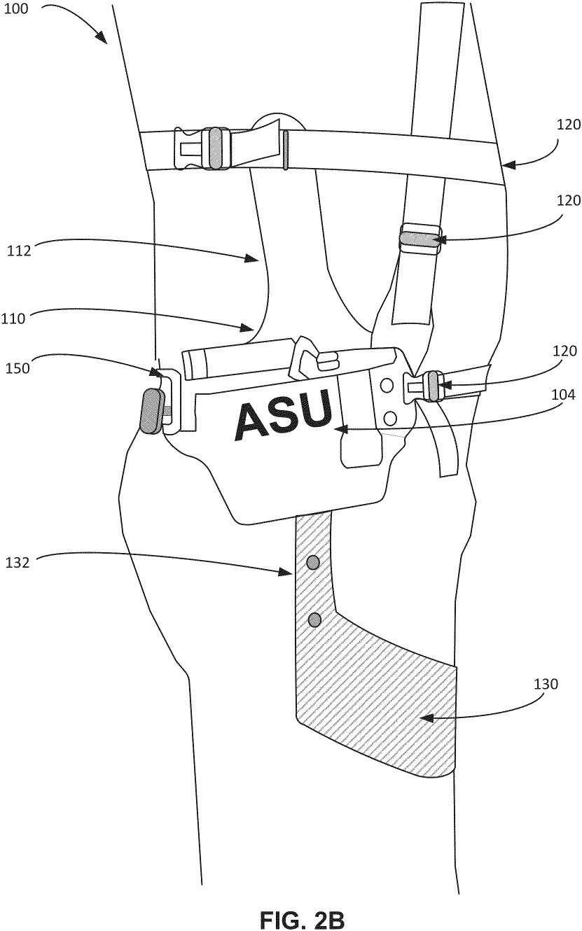

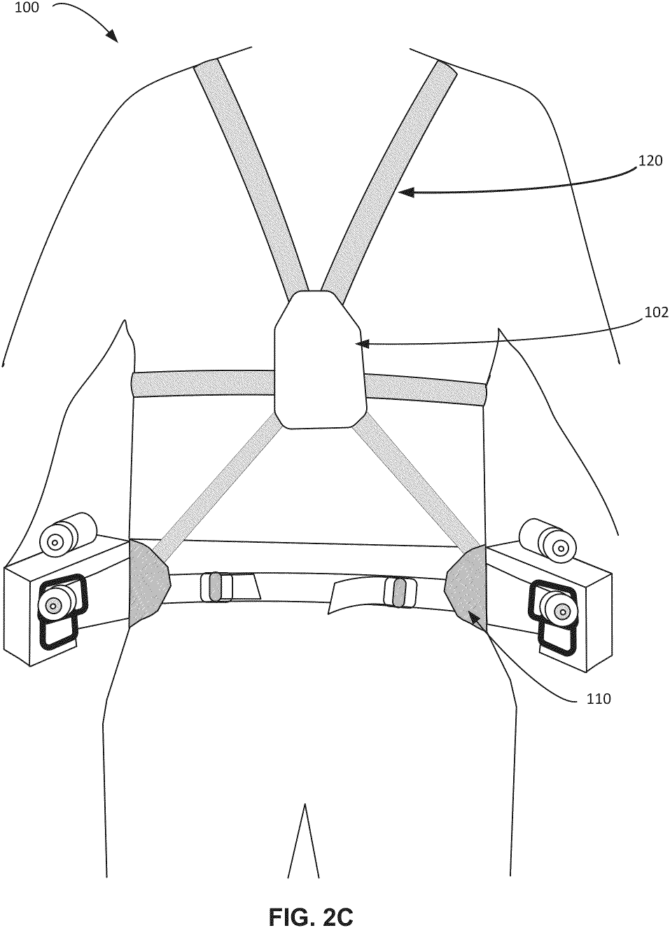

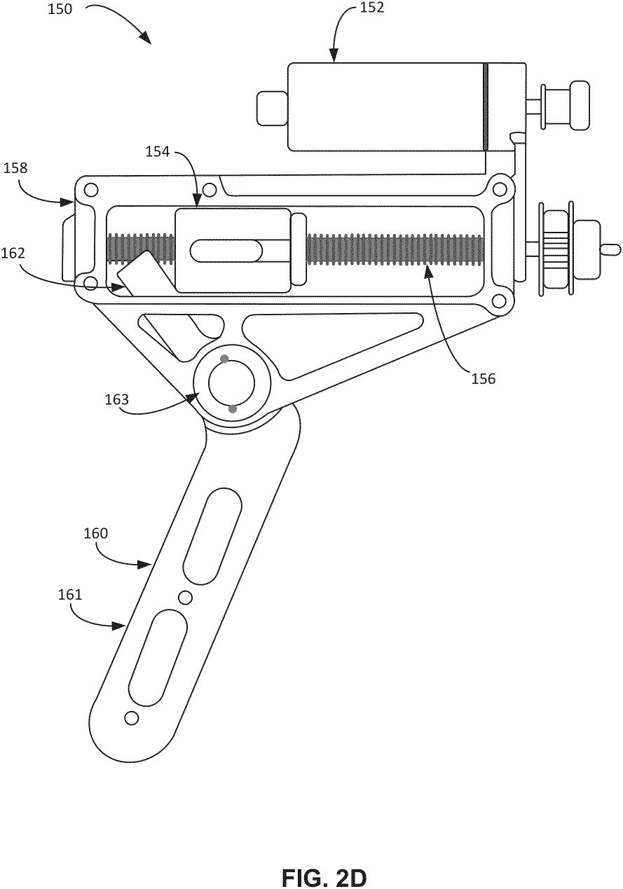

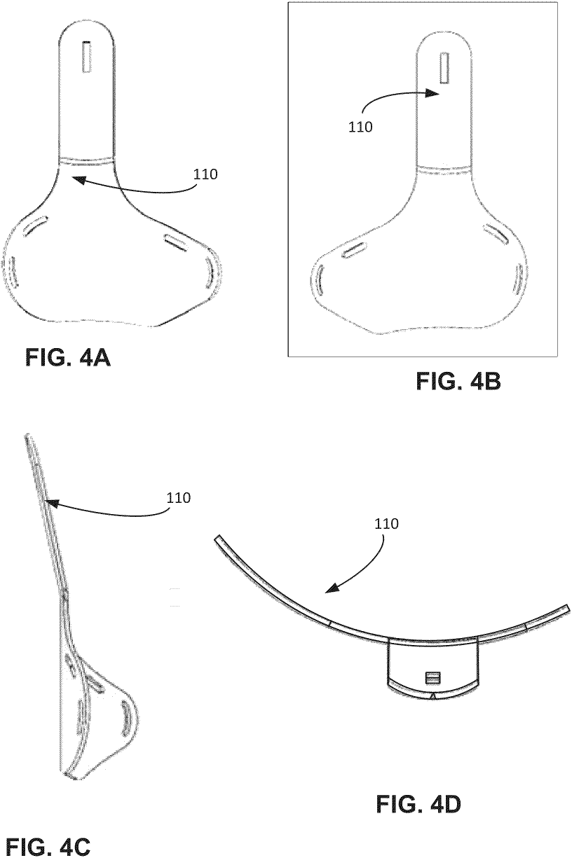

In various exemplary embodiments, an exemplary unique design has removed the rigid brace at the hips and replaced it with a more comfortable and intuitive backpack-type strapping (for example, see FIGS. 2A-2C.). The side view shows a hard, side, vertical bracing 110 (also referred to herein as “lateral pelvic plates”) that holds the motor units 150 (also referred to herein as electric actuators) in place. Vertical bracing 110 includes a plurality of attachment points whereby a plurality of soft straps 120 are connected thereto to secure vertical bracing 110 to the user. These plates 110 may be planar, concave, convex, curved, saddle-shaped (i.e., having multiple curvatures), and/or the like. In various exemplary embodiments, a lateral pelvic plate 110 may be configured as seen in FIGS. 4A, 4B, 4C, and 4D. By replacing the hard-plastic orthosis from prior devices, a more customized fit can be achieved. The strapping 120 also reduces the overall weight of the device, which is an important design component. Additionally, vertical bracing 112 was integrated into the lateral pelvic plate. The large hip orthosis was replaced with the lateral pelvic plates 110 and straps 120. The bracing around the ribs was replaced with straps 120. The backpack strapping 120 over the shoulders was also added to prevent vertical shifting. Vertical shifting was originally achieved by tighter horizontal strapping, which caused discomfort over prolonged use. Desirably, the lateral, pelvic plates 110 keep the lower back straight to require the user to squat and lift in a good form. Other designs have tried to use hard plastic plates along the spine to require good form. However, when one bends over the back arches touching the vertical structure along the spine causing discomfort. Accordingly, the unique design and configuration of system 100 constrains the lower back in a comfortable design.

A first and a second lateral pelvic plate 110 may be provided, each lateral pelvic plate 110 configured to support the use of a dedicated motor to assist the user of the back support device in lifting an object. It will be appreciated that, in system 100, the lateral pelvic plates 110 constrain and hold the trunk and stabilize the core of the body. Prior approaches use hard structures along the spine which are uncomfortable. Additionally, as compared to prior approaches, system 100 is: light; comfortable and does not cover the lower back which can cause the user to sweat and overheat; designed to ensure that the user has a good posture when lifting and pushing; and easily adjusted.

System 100 further includes a hard leg brace 130 configured to surround at least a portion of the user’s leg. In this illustrated embodiment, leg brace 130 wraps around the front half of the user’s thigh. Leg brace 130 includes a vertical arm 132. Vertical arm 132 may be integrated into the leg brace 130 as a single, unitary member. Vertical arm 132 may be configured to rotate in the same axis as the user’s hip (sagittal plane).

System 100 further includes a power source 102, such as a battery, for powering the motor unit 150. Power source 102 may be supported at the user’s back by straps 120. Power source 102 may be activated or deactivated by the user.

With reference now to FIG. 2D, an isolated view of the motor unit 150 is illustrated, in accordance with various embodiments. Motor unit 150 may include an electric motor 152 and a translating block 154. Translating block 154 may be threadingly coupled to a screw 156 configured to rotate about a longitudinal axis thereof. Motor 152 may cause screw 156 to rotate or spin and in turn, the spinning of screw 156 may cause translating block 154 to translate along the longitudinal axis of screw 156. The direction that translating block 154 translates depends on the rotational direction that screw 156 spins. For example, rotation of screw 156 in a first direction may cause translating block 154 to translate in a first direction (e.g., left in FIG. 2D) while rotation of screw 156 in a second, opposite direction may cause translating block 154 to translate in a second direction (e.g., right in FIG. 2D). Screw 156 may be pivotally mounted to frame 158. Motor 152 may be mounted to a frame 158. Motor 152 may be controlled by computing device 104.

Motor unit 150 further includes an lever arm 160 pivotally coupled to frame 158. Lever arm 160 may include a first arm 161 extending from the pivot 163 and configured to be attached to vertical arm 132 (see FIG. 2B). In various embodiments, vertical arm 132 and first arm 161 are manufactured as separate pieces and removably or non-removably coupled together. In various embodiments, vertical arm 132 and first arm 161 are integrally formed as a single piece. Lever arm 160 further includes a second arm 162 extending from the pivot 163. First arm 161 and second arm 162 may be disposed opposite the pivot 163 from one another. Translating block 154 may be configured to contact or engage second arm 162 which in turn causes lever arm 160 to rotate about pivot 163. In this manner, a force may be imparted into a user’s leg, for example to assist the user in squat recovery and/or a pushing maneuver. Translating block 154 may provide powered thrust to lever arm 160 over a portion of hip extension movement of a user. Translating block 154 may provide between thirty and seventy degrees of powered thrust to lever arm 160 in various embodiments, between forty and seventy degrees of powered thrust to lever arm 160 in various embodiments, and about sixty seven degrees of powered thrust to lever arm 160 in various embodiments. Translating block 154 may provide unidirectional thrust to assist hip extension of the user.

By placing translating block 154 adjacent to second arm 162, the translating block may be moved out of the way when not in use (i.e., to the right in FIG. 2D), rendering the translating block 154 “invisible” to the user’s motion (i.e., the translating block does not physically contact second arm 162 as the second arm rotates back and forth as the user walks and/or moves around (i.e., as the user move’s his or her leg back and forth). In this regard, translating block 154 may be moved from a first mode where the translating block 154 engages second arm 162 and a second mode where the translating block 154 is disengaged from the second arm and the lever arm 160 is able to freely rotate about pivot 163. For example, in the second (free) mode (e.g., the motors turned off in a free mode), the user can knee, take wide and cross steps, rotate the hip, and crawl.

With combined reference now to FIG. 2A through FIG. 2D, system 100 further includes a computing device 104 which includes one or more controllers (e.g., processors) and one or more tangible, non-transitory memories capable of implementing digital or programmatic logic. In various embodiments, for example, the one or more controllers are one or more of a general purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various embodiments, the computing device 104 controls, at least various parts of and operation of various components of, the system 100. For example, the computing device 104 controls various parameters of system 100, such as the operation of motor 152. Computing device 104 may determine when to activate the powered exoskeleton (e.g., by selectively positioning translating block 154 via the motor 152).

In various embodiments, computing device 104 may implement a control schema to allow for different movement activities. A poorly executed system may tend to cause the system to move during the wrong motions potentially causing injury. To control the system 100, a redundant activity recognition algorithm may be implemented with a basic model and/or an AI trained model. Both models may operate on the white-list principle, in which the system will only activate when it is certain that a lift or push is taking place. For all others it will not engage, in various embodiments. Computing device 104 may utilize one or more inertial measurement units (IMUs) fitted in the control chip at the hip (e.g., 1 on each side), and rotation sensors about the axis of rotation (e.g., one on each side) to detect and/or determine when to activate the exoskeleton (e.g., to identify the signatures of squatting, sitting, pushing, walking, jogging, climbing stairs, vehicle entry/exit, etc.). Using sensor feedback, computing device 104 may selectively operate motor units 150 in the first mode to provide unidirectional thrust to assist hip extension or in the second mode to allow the user to freely extend or contract the hip.

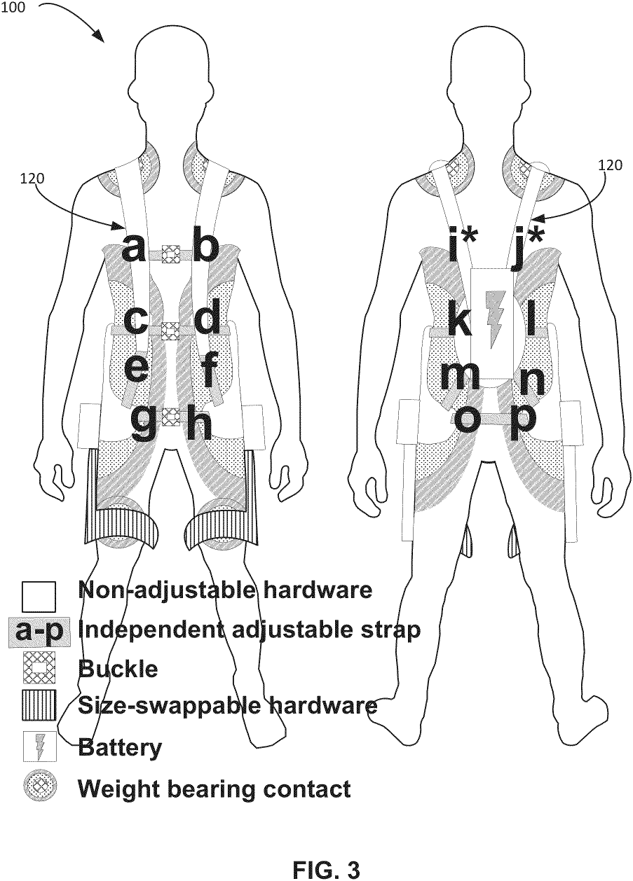

With reference now to FIG. 3, in various exemplary embodiments system 100 includes a system of soft, adjustable straps 120. The straps 120 may be coupled to the adjustable vest; alternatively, the straps may comprise the adjustable vest. When a torque is applied by the motors to the thighs in the exoskeleton, the lateral pelvic plates 110 want to rotate. The adjustable straps O-P and C-D are uniquely placed to keep the plates from rotating. Adjustable strap O-P (also referred to herein as a first strap) may extend horizontally between upper ends of vertical bracing 112 and around the user’s waist at or just below the ribs. Adjustable strap C-D (also referred to herein as a second strap) may extend horizontally between lower ends of lateral pelvic plates 110 and around the user’s hip. It will be appreciated that this configuration (i.e., a strap in the back at the lower waist and a strap in the front near the sternum) creates a desirable coupling for holding lateral pelvic places 110 in a desired position. Stated differently, straps 120 are configured to reduce rotation of each lateral pelvic plate 110 during activation of the powered exoskeleton. The soft straps 120 are adjustable so that the system can easily be mounted on varying sized individuals.

Straps I* and J*, and E and F allow the shoulder straps to be adjusted. The shoulder straps keep the exoskeleton from moving vertically. Straps G and H allow the hip belt to be adjusted. Straps A and B allow the chest strap to be adjusted. Sizes of soft straps: The lengths of the straps in an exemplary embodiment are shown in Table 1.

TABLE 1

Measurement chart for the adjustable sections for maximum fit and comfort
Strapping

| FIG. 3 Reference | Minimum | Maximum |
|---|---|---|
| a | 2” | 11.5” |
| b | 1.5” | |
| c, d | 3” | 14.5” |
| e, f | 1.5” | 14” |
| g, h | 2” | 16.5” |
| i, j | 12” | |
| k, l | 2” | 11” |
| m,n | 5” | |
| o, p | 5” | 13” |

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A wearable robotic device for lifting and pushing, the robotic device comprising:
a hip-mounted, powered exoskeleton;
an adjustable vest coupled to the powered exoskeleton;
a power source for powering the powered exoskeleton; and
a computing device for controlling the robotic device and determining when to activate the powered exoskeleton.

2. The robotic device of claim 1, wherein the powered exoskeleton is configured to provide unidirectional thrust to assist hip extension.

3. The robotic device of claim 2, wherein the powered exoskeleton is further configured to provide unidirectional thrust on a portion of hip extension movement of a user.

4. The robotic device of claim 3, wherein the powered exoskeleton comprises a first and a second lateral pelvic plate.

5. The robotic device of claim 4, wherein the adjustable vest comprises one or more straps configured to reduce rotation of each lateral pelvic plate during activation of the powered exoskeleton.

6. The robotic device of claim 4, wherein the adjustable vest comprises a first strap extending horizontally between a first upper end of the first lateral pelvic plate and a second upper end of the second lateral pelvic plate.

7. The robotic device of claim 6, wherein the adjustable vest further comprises a second strap extending horizontally between a first lower end of the first lateral pelvic plate and a second lower end of the second lateral pelvic plate.

8. The robotic device of claim 7, wherein the adjustable vest further comprises a pair of adjustable shoulder straps.

9. A back support device, comprising:
a first and a second lateral pelvic plate; and
at least one strap configured to reduce rotation of each lateral pelvic plate and configured to support the lumbar region of a user of the back support device.

10. The back support device of claim 9, further comprising an adjustable vest coupled to the at least one strap.

11. The back support device of claim 9, further comprising a plurality of straps that form an adjustable vest.

12. The back support device of claim 9, wherein each lateral pelvic plate is configured to support the use of a motor to assist a user of the back support device in lifting an object.

13. The back support device of claim 9, wherein each lateral pelvic plate is configured to support the use of a motor to assist a user of the back support device in pushing an object.

14. The back support device of claim 9, wherein each lateral pelvic plate is configured to be coupled to a passive exoskeleton.

15. The back support device of claim 9, further comprising a quasi-passive exoskeleton coupled to the first and the second lateral pelvic plate, wherein the quasi-passive exoskeleton comprises a power source that can be activated or deactivated.

16. The back support device of claim 9, further comprising a powered exoskeleton coupled to the first and the second lateral pelvic plate, wherein the powered exoskeleton comprises a power source and an electric actuator.

17. The back support device of claim 9, further comprising a first and a second motor unit respectively coupled to the first and the second lateral pelvic plate, each motor unit comprising:
a frame:
a motor mounted to the frame;
a screw rotatably mounted to the frame;
a translating block threadingly coupled to the screw; and
a lever arm pivotally coupled to the frame:
wherein the translating block is configured to contact the lever arm to rotate the lever arm about a pivot.

18. The back support device of claim 17, wherein the translating block is configured to move from a first mode where the translating block engages the lever arm and a second mode where the lever arm is able to freely rotate about the pivot.

19. The back support device of claim 17, further comprising a leg brace coupled to the lever arm, wherein the leg brace is configured to rotate with the lever arm about the pivot.

20. A method for using a wearable robotic device comprising:
positioning a first lateral pelvic plate at a first side of a user’s hip;
positioning a second lateral pelvic plate at a second side of the user’s hip;
positioning a first strap to extend horizontally between a first upper end of the first lateral pelvic plate and a second upper end of the second lateral pelvic plate, wherein the first strap extends across a user’s waist;
adjusting a length of the first strap;
positioning a second strap to extend horizontally between a first lower end of the first lateral pelvic plate and a second lower end of the second lateral pelvic plate, wherein the second strap extends across a user’s hip;
adjusting a length of the second strap;
contracting a user’s hips; and
extending the user’s hips with the support of the wearable robotic device.
